(19) United States
(12) Patent Application Publication
(10) Pub. No.: US 2020/0175514 A1
(43) Pub. Date: Jun. 4, 2020

(54) USING A BLOCKCHAIN TO ESTABLISH A WEB OF TRUST

(71) Applicant: Palo Alto Research Center Incorporated, Palo Alto, CA (US)

(72) Inventors: Eric Allan Bier, Palo Alto, CA (US); Marc E. Mosko, Santa Cruz, CA (US)

(21) Appl. No.: 16/209,648

(22) Filed: Dec. 4, 2018

(51) Int. Cl. G06Q 20/40; G06Q 30/06; G06F 16/182; H04L 9/08; H04L 9/32

(52) U.S. Cl. CPC G06Q 20/401; G06Q 30/0609; G06F 16/1824; H04L 2209/38; H04L 9/083; H04L 9/3247; G06F 16/1834

(57) ABSTRACT

A method of using a blockchain to establish a web of trust that includes receiving a request to add a transaction to a blockchain, wherein the transaction identifies a sale of a good or service. The method further includes determining that a prior transaction identifying the good or service is not already stored on the blockchain. The method further includes, in response to determining that the prior transaction identifying the good or service is not already stored on the blockchain: sending, by a processing device, a first request to a first third-party institution to verify information of the transaction block, in response to sending the first request, receiving a first verification of the information of the transaction from the first third-party institution, and adding, by the processing device, the first verification, in a first verification transaction, to the blockchain.

### TECHNICAL FIELD

Implementations of the present disclosure relate to using a blockchain to establish a web of trust.

### BACKGROUND

Blockchains provide a reliable, distributed, immutable, and persistent ledger of transactions. However, there does not currently exist an efficient way to use blockchain technology to track the commodities being bought and sold because these commodities exist outside of the blockchain. Disadvantageously, without a verification of transaction information (e.g., buyer, seller, commodity, price, date recorded, etc.) there exists an increased opportunity for fraudulent transactions on the blockchain.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating a blockchain system, in accordance with some embodiments.

FIG. 2 is a block diagram illustrating blockchain transaction blocks, in accordance with some embodiments.

FIG. 3 is a block diagram illustrating a first example transaction block, in accordance with some embodiments.

FIG. 4 is a block diagram illustrating data of an example transaction block, in accordance with some embodiments.

FIG. 5 is a block diagram illustrating a second example transaction block including web of trust blocks, in accordance with some embodiments.

FIG. 6 is a graphical flow diagram illustrating a first method of using blockchain to establish a web of trust, in accordance with some embodiments.

FIG. 7 is a graphical flow diagram illustrating a second method of using blockchain to establish a web of trust, in accordance with some embodiments.

FIG. 8 is an illustration showing an example computing device which may implement the embodiments described herein.

### DETAILED DESCRIPTION

Blockchain technology may provide a reliable, distributed, public, immutable ledger of transactions, and it is being used as the basis for a variety of distributed applications. In addition, by reviewing the transactions in a blockchain, one can accurately determine how much currency a given entity has received and spent on blockchain transactions and the current balance for that entity. In other words, a blockchain can keep track of the amount of currency currently possessed by an individual who is associated with the blockchain.

However, the many advantages of blockchains come at a cost. Unfortunately, current blockchains are limited to tracking currency. They are unable to reliably track the ownership and transfer of other commodities and services, such as automobiles or houses. As a result, tracking such commodities and services still requires traditional expensive, centralized, trusted authorities. Here are some of the issues we see with using blockchains for this kind of tracking.

Current blockchain technologies suffer from a variety of related issues. For example, because physical commodities and services exist in the real world, outside of the blockchain, it may be difficult for the peers in a blockchain network to verify corresponding transactions. For example, if a blockchain records that seller S sold commodity C to buyer B on date D for price P, that record could be false in many ways: S may not have been the actual owner of C, or C may not have been the actual commodity sold, for example.

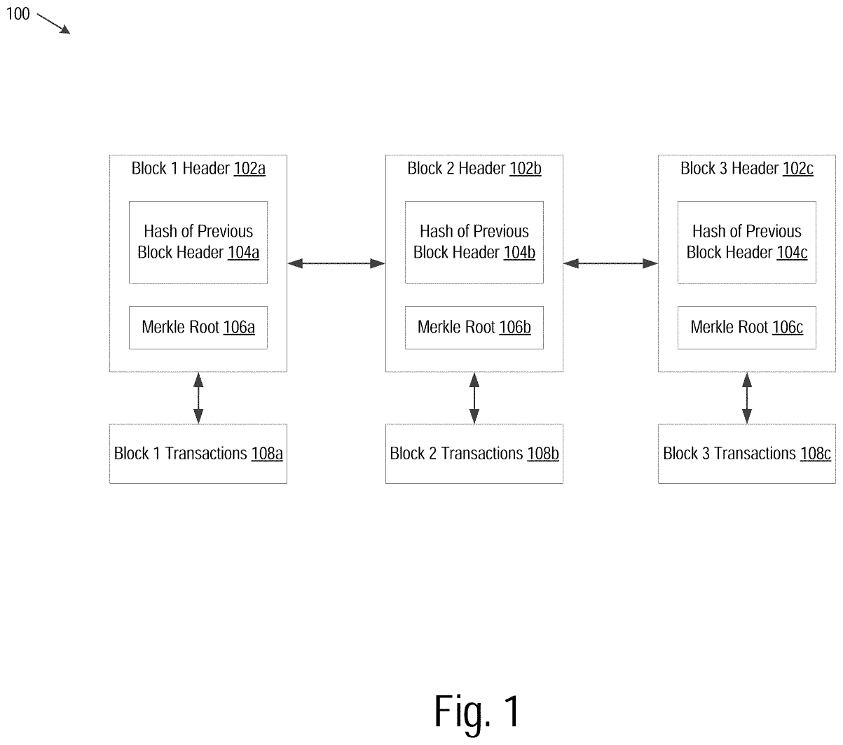

Advantageously, the embodiments described herein provide for efficient, reliable, and accurate solutions to the above problems, and others, by using Web of Trust transactions (e.g., “verification transactions”) to verify blockchain transaction details. In one embodiment, Web of Trust transactions may be added to blockchain transaction blocks, in addition to “sale” transactions, to verify facts about a corresponding commodity, service, or institution. Additional details describing Web of Trust transactions are provided with respect to FIGS. 1-8.

It should be noted that although some of the embodiments and examples provided herein are described with respect to real-estate transactions for convenience, the methods and systems described herein are not limited to any particular type of transaction or data. The methods and systems described herein may be used to more efficiently store any type of data on any type of blockchain.

FIG. 1 is a block diagram illustrating a blockchain system 100, in accordance with some embodiments. Although specific components are disclosed in blockchain system 100, it should be appreciated that such components are examples. That is, embodiments of the present invention are well suited to having various other components or variations of the components recited in blockchain system 100. It is appreciated that the components in blockchain system 100 may operate with components other than those presented, and that not all of the components of blockchain system 100 may be required to achieve the goals of blockchain system 100.

Blockchain system 100 may be a decentralized, peer-to-peer networking system. Without a central authority, operations (e.g., transactions) of blockchain system 100 may be managed collectively by peers in the system. In FIG. 1, blockchain system 100 is a decentralized public database that includes a variety of components, including blockchain headers (102a-c) and transactions (108a-c), and subcomponents, including hashes of previous block headers (104a-c) and Merkle Roots (106a-c). In one embodiment, each block contains a record of recent transactions (e.g., transactions 108a) and a header (e.g., 102a) including a reference to the block that came before it (e.g., 104a) and the Merkle Root (e.g., 106a) among other data (e.g., a timestamp).

In one embodiment, a blockchain is collectively maintained by “miners,” who are members within the network that compete to validate blockchain transactions in each block by solving the complex mathematical problem associated with the block. In one embodiment, miners are incentivized to validate blockchain transactions by rewarding them with some amount of monetary compensation upon successful completion.

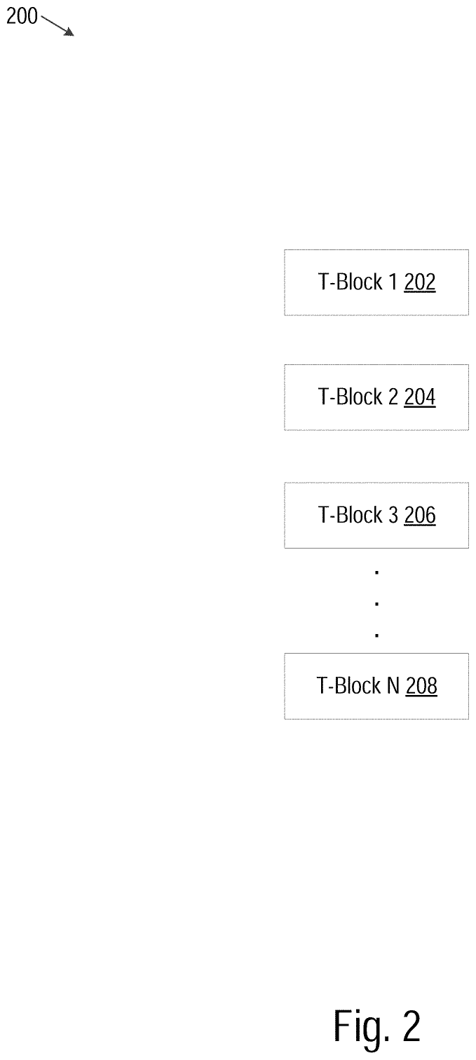

In one embodiment, as described herein, data contained in a block header and/or block transaction data may correspond to the data described herein with respect to Web of Trust transactions. For example, Block 1 transactions 108a may include both sale transactions and Web of Trust transactions, as described herein. FIG. 2 provides additional details regarding transaction blocks.

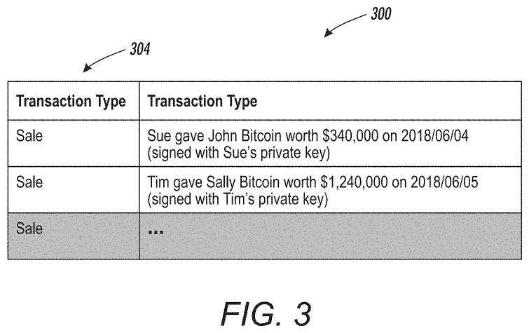

FIG. 2 is a block diagram illustrating blockchain 200 transaction blocks 202-208, in accordance with some embodiments. In one embodiment, each of the transaction blocks (e.g., T-blocks) 202-208 may contain uncompressed transaction data. As illustrated, the blockchain 200 is a sequence of T-blocks 202-208. Each T-block (e.g., 202-208) in the blockchain 202, may consist of a list of transactions. Each transaction may then contain a list of data fields that describe that particular transaction. FIG. 3 illustrates an example T-Block (e.g., T-block 1 202), represented as a table of data.

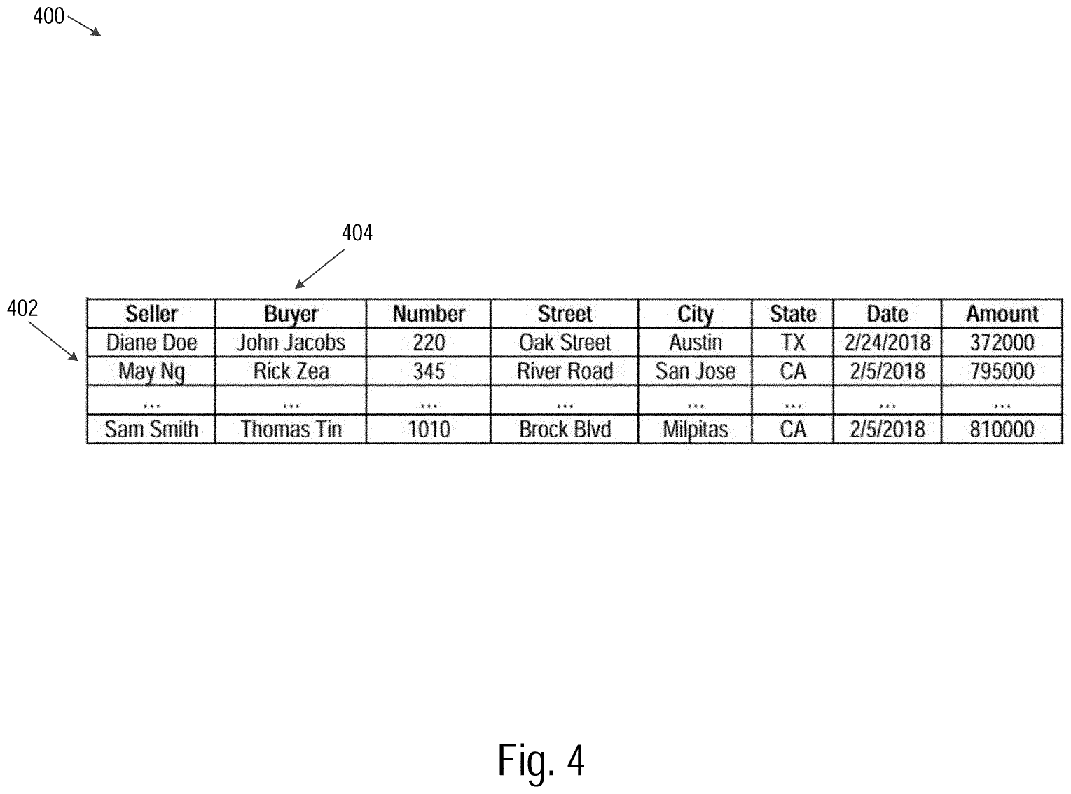

FIG. 3 is a block diagram illustrating a first example transaction block 300, in accordance with some embodiments. As described above, transaction block 300 may represent a data view of a T-block (e.g., T-block 1 202 of FIG. 2). Each row (e.g., 302) of the transaction block 300 represents a transaction and each column represents either a transaction type 304 or transaction details 306. In one embodiment, each item in the block represents a sale (e.g., in column 304). In such a case, column 306 may include a small amount of information about the buyer, seller, and amount for each transaction. In one embodiment, each transaction is signed by the buyer, because the buyer is spending cryptocurrency on the transaction and the blockchain system verifies that the buyer has enough cryptocurrency to enable the sale. In such an example, there may be only one transaction type (e.g., “sale”) and only details pertaining to the buyer, seller, and sale amount may be included. In another embodiment, additional transaction details may be included in the transaction block, as described with respect to FIG. 4.

FIG. 4 is a block diagram illustrating data 400 of an example transaction block, in accordance with some embodiments. Each row (e.g., 402) of the transaction block represents a transaction and each column (e.g., “Buyer” 404) represents one field of data pertaining to that transaction. In this example, all of the transactions are real estate sales. In other examples, any other type of transaction may be used.

In one embodiment, the transaction blocks of FIGS. 1-4 require a significant amount of data for each transaction. For example, the last row of FIG. 4 includes roughly 60 characters, even though the names of people and streets are relatively short. If each character requires 16 bits, as is the case in Unicode, it would take 120 bytes to represent this row, plus additional space to encode field boundaries, a unique ID for the transaction and so on. Advantageously, by performing a compression algorithm over each transaction in the block, (e.g., using dictionary coding) the storage capacity of transaction blocks may be greatly increased.

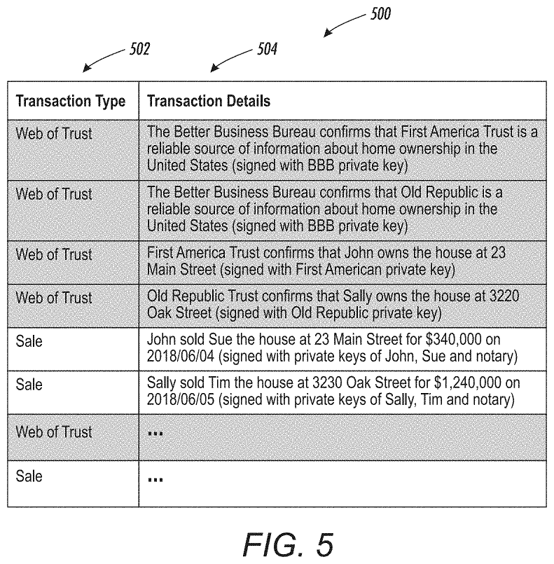

FIG. 5 is a block diagram illustrating a second example transaction block including web of trust transactions, in accordance with some embodiments. In one embodiment, the transaction types of column 502 may include various transaction types, including, but not limited to, “sales” and “Web of Trust” transactions. In one embodiment, each “sale” transaction is like a traditional blockchain transaction. However, the sale transactions described herein may include more information about the buyer, seller, and commodity being sold. Furthermore, the transaction may be signed by both the buyer and the seller, to verify that the seller is indeed willing to sell the commodity in question. The “Web of Trust” transactions, instead of describing a sale, may confirm a fact about a commodity or an institution. Web of Trust transactions may provide enough information to trust all of the important details of the transactions, including the identity of the buyer, seller, and commodity, the ownership of the commodity going into the sale, etc.

In one embodiment, the systems and methods provided herein include recording blockchain transactions in a variety of scenarios. For example, blockchain transactions may be recorded differently, according to three possible examples: In the first example, the commodity has never been the object of a transaction on the blockchain before. In the second example, the commodity has been the object of a transaction on that blockchain before and the most recent previous transaction is also on the blockchain. In the third example, the commodity has been the object of a transaction on that blockchain before, but the most recent previous transaction involving that object is not on the blockchain.

In the first example, steps may be taken to make sure that the initial information recorded on the blockchain about the commodity is accurate, as future transactions will depend on this baseline information. To do this, the credibility of existing institutions may be relied upon for verifying transactions. For example, institutions may verify the owner of the commodity and other information about the transaction as appropriate. A message may be sent to the institution, requesting that the institution digitally sign that verification, and the signed verification may be placed on the blockchain (e.g., as a Web of Trust transaction) along with the other details of the transaction.

In some embodiments, the signing institution may also be verified as legitimate and trustworthy to identify the owner of this kind of commodity. In order to verify an institution “I1,” a request may be sent to another institution, “I2,” to verify I1. In one embodiment, this may be performed by creating a special institution verification transaction on the blockchain, in which I2 vouches that I1 is legitimate and appropriate for this kind of commodity. The verification may be digitally signed by I2 and the whole verification transaction may be added to the blockchain.

In one embodiment, the legitimacy and appropriateness of I2 may be verified to perform the verification of institutions. This may be done with additional verification transactions, as described above. The result is a directed graph of verification transactions, because each commodity or institution can potentially be verified by more than one recommending institution, and each institution can verify more than one commodity or institution.

Returning to the transaction for a commodity that is new to the blockchain, this transaction may be verified and added to the blockchain only if the system described herein is satisfied by one or more chains of verification from the commodity to an institution that the blockchain community trusts.

Consider the following example. Say that Ray Rivers is selling the house at 123 Main Street, Anytown, PA to Samantha Smith in 2014. First American Title verifies that Ray was the actual owner, and that there are no outstanding liens on the property, etc. They digitally sign a statement to that effect and put it on the blockchain. First American Title, in turn, has been previously verified by the Better Business Bureau, which declares that it is still in business, that it is in the business of verifying real estate deeds, and that it is highly rated. A verification transaction with that information was placed on the blockchain several years ago and has not been updated nor retracted. The Better Business Bureau, in turn, is on list of organizations trusted by the blockchain peers. In this case, the transaction meets the verification criteria and is added to the blockchain.

In one embodiment, for the sale of a commodity already on the blockchain, if a given market agrees to record all of its transactions on a given blockchain, then subsequent transactions on a commodity that is already recorded on the blockchain can be made with less verification from traditional institutions. For example, if all real estate transactions in Pennsylvania are added to a given blockchain and if 123 Main Street, Anytown, PA appears in a transaction again, the system will search through the blockchain and detect that the most recent buyer was Samantha Smith in 2014. If the new transaction has Samantha selling the house to Tim Townsend, then the system may determine that the new transaction is consistent with the older one and may not require verification of the seller.

In one embodiment, the system may guard against fraudulent transactions on the blockchain. In particular, the system may verify that Samantha wants to sell this house, that she has agreed to the price as claimed, and that she has selected Tim Townsend as the buyer. The system may further make sure that Tim wants to buy this house and that he has agreed to the price as claimed. To accomplish this, the system may request that Samantha sign the transaction details with her private key and that Tim sign them with his private key. The system may further request that one or more notaries digitally sign the transaction after contacting Samantha and Tim and verifying their intentions.

In one embodiment, in the example above, the system may be able to skip some expensive verification steps based on the assumption that all transactions are on the blockchain. However, in the real world, some transactions will inevitably be left off the blockchain, which may provide increased opportunity for errors and fraud. For example, Tim may sell 123 Main Street to Violet. The sale may be left off the blockchain by accident or intentionally. Later, Violet may want to sell the house to William. When William tries to add the transaction to the blockchain, the verification will fail, because Tim still appears to be owner, instead of Violet. In this case, the system may proceed much as it would as if 123 Main Street was joining the blockchain for the first time. For example, the system may request that the title company verify that Violet is indeed the current owner. The system may then either add the missing transaction to the blockchain, or add a new verification transaction to the blockchain that includes the correct, updated information. With respect to the above example, the system may add the missing transaction in which Tim sold the house to Violet, requesting that the transaction be digitally signed by Tim, Violet, and a notary, with an annotation that it is being added long after the actual sale. Alternatively, the system may add a new verification transaction to the blockchain declaring that the house does now belong to William, digitally signed by a Title company. In this case, some of the history of sales of the property may be missing from the blockchain, but the property is once again in good standing on the blockchain for future transactions.

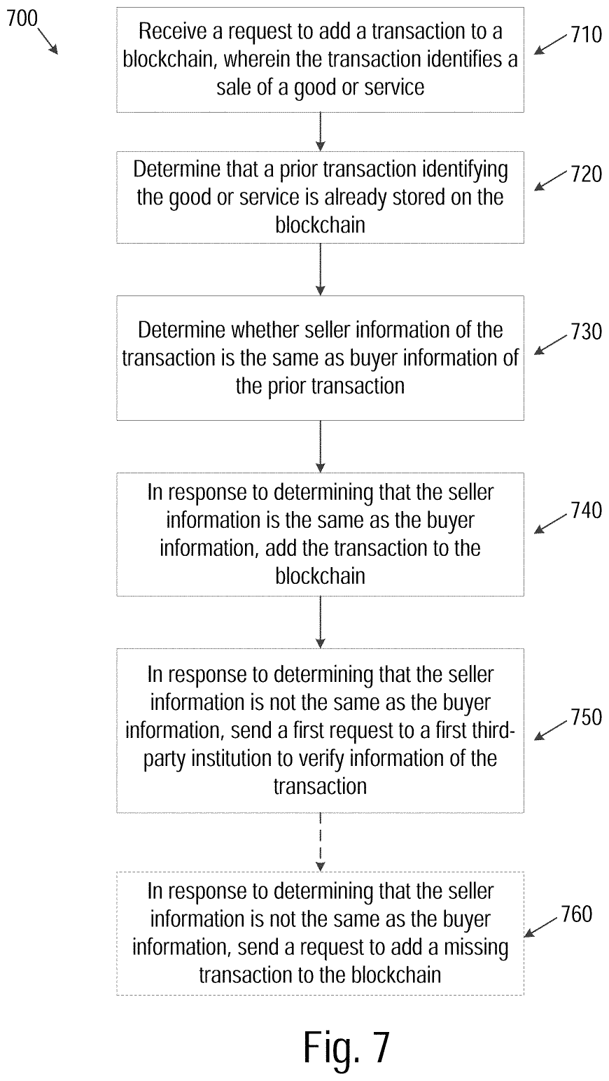

In some embodiments, support for an institution may be withdrawn from the blockchain. For example, over time, a reputable firm may go out of business, change management, become disreputable, and in general change status. If company A has previously declared its trust in company B, but no longer trusts company B, it can add (e.g., and digitally sign) a new transaction to the blockchain modifying or withdrawing its verification. Both statements remain on the blockchain, as it is a persistent, immutable record. However, the newer statement may take precedence over the older one when the blockchain peer machines decide whether or not to verify a new transaction. Adding transactions to a blockchain according to the example listed above is further described with respect to FIG. 7.

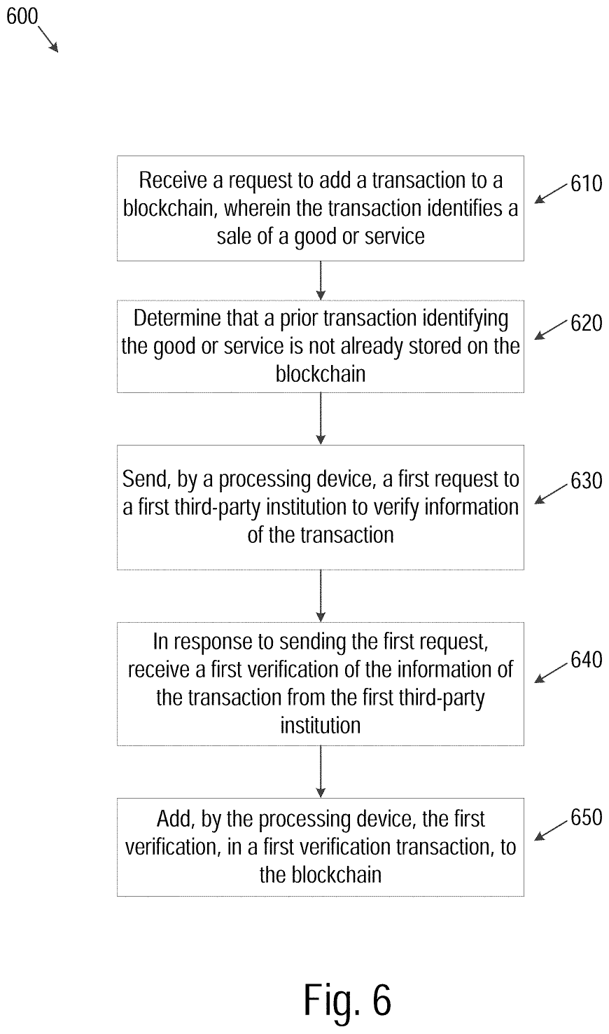

FIG. 6 is a graphical flow diagram 600 illustrating a first method of using a blockchain to establish a web of trust, in accordance with some embodiments. For example, the processes described with reference to FIG. 6 may be performed by the processing logic of a blockchain system, as described herein.

Referring to FIG. 6, at block 610, processing logic receives a request to add a transaction to a blockchain. In one embodiment, the transaction identifies a transfer (e.g., sale, trade, license, etc.) of a good or service. At block 620, processing logic determines that a prior transaction identifying the good or service is not already stored on the blockchain ledger. In response to determining that the prior transaction identifying the good or service is not already stored on the blockchain ledger, at block 630, processing logic sends, by a processing device, a first request to a first third-party institution to verify information of the transaction. In various embodiments, the request is sent by a human being, such as the seller, the buyer, or one of their agents (e.g., via a client device).

At block 640, in response to sending the first request, processing logic receives a first verification of the information of the transaction from the first third-party institution. In one embodiment, the first verification includes a unique digital signature of the first third-party institution. At block 650, processing logic adds, by the processing device, the first verification, in a first verification transaction, to the blockchain.

In one embodiment, processing logic may further determine whether the first third-party institution is a trusted institution, and in response to determining that the first third-party institution is not a trusted institution: send a second request to a second third-party institution to verify the original transaction (and/or verify the first verification of the information of the transaction), receive a second verification of the first verification from the second third-party institution, and add the second verification, in a second verification transaction, to the blockchain. In one embodiment, to determine whether the first third-party institution is a trusted institution processing logic may determine that a recent signed transaction from a second third-party institution verifies that the first third-party institution can be trusted, determine that a chain of verification transactions already on the blockchain verifies that the second third-party institution can be trusted, and determine that the chain of verification transactions includes an institution that is on a list of trusted institutions verified by a plurality of blockchain peers. In another embodiment, to determine whether the first third-party institution is a trusted institution processing logic may determine that the first third-party institution is on the list of trusted institutions verified by the plurality of blockchain peers.

In one embodiment, if the first third-party institution is simply not yet known on the blockchain, processing logic may request verification of the first third-party institution in order to establish the web of trust. In this case, processing logic may send a second request to a second third-party institution to verify the first third-party institution, receive a second verification of the first third-party institution, and add the second verification, in a second verification transaction, to the blockchain.

In one embodiment, in response to receiving the second verification, processing logic may add the transaction to the blockchain. In one embodiment, the transaction, the first verification and the second verification represent a directed path in a larger graph of verification transactions on the blockchain.

In another embodiment, processing logic may determine that the first third-party institution is a trusted institution, and, in response to receiving the first verification, add the transaction to the blockchain. In one embodiment, processing logic may compress the transaction (e.g., using dictionary compression) before adding the transaction to the blockchain. In yet another embodiment, processing logic may add any missing transactions to the blockchain at any point throughout this process, e.g., in response to a determination that the web of trust is incomplete.

FIG. 7 is a graphical flow diagram illustrating a second method of using a blockchain to establish a web of trust, in accordance with some embodiments. For example, the processes described with reference to FIG. 7 may be performed by the processing logic of a blockchain system, as described herein.

Referring to FIG. 7, at block 710, processing logic may receive a request to add a transaction to a blockchain. In one embodiment, the transaction identifies a transfer of the rights (e.g., sale, exchange, license, etc.) of a good or service. At block 720, processing logic may determine that a prior transaction identifying the good or service is already stored on the blockchain. At block 730, in response to determining that the prior transaction identifying the good or service is already stored on the blockchain, processing logic may determine whether seller information of the transaction is the same as buyer information of the prior transaction, and in response to determining that the seller information is the same as the buyer information, add the transaction to the blockchain (block 740). At block 750, processing logic may, in response to determining that the seller information is not the same as the buyer information, send a first request to a first third-party institution to verify information of the transaction. Optionally, at block 760, if processing logic determines that there are previous transactions in the blockchain that mention the current commodity, but that the previous buyer does not match the current seller, processing logic may send a request (e.g., to an appropriate institution) to add the missing transaction(s).

In one embodiment, in response to determining that the seller information is not the same as the buyer information, the processing logic may receive a first verification of the information of the transaction from the first third-party institution and add the first verification, in a first verification transaction, to the blockchain. In one embodiment, the first verification includes a unique digital signature of the first third-party institution.

In another embodiment, processing logic may determine that the first third-party institution is not a trusted institution (or the trustworthiness of the institution is not known) and in response to determining that the first third-party institution is not a trusted institution: send a second request to a second third-party institution to verify the original transaction (and/or verify the first verification of the information of the transaction block), receive a second verification of the first verification from the second third-party institution, and add the second verification, in a second verification transaction, to the blockchain. Processing logic may further, in response to receiving the second verification, add the transaction to the blockchain.

Processing logic may further determine that the first third-party institution is a trusted institution, and, in response to receiving the first verification, add the transaction to the blockchain. Processing logic may further add a missing transaction to the blockchain at any point throughout this process.

Various operations are described as multiple discrete operations, in turn, in a manner that is most helpful in understanding the present disclosure, however, the order of description may not be construed to imply that these operations are necessarily order dependent. In particular, these operations need not be performed in the order of presentation.

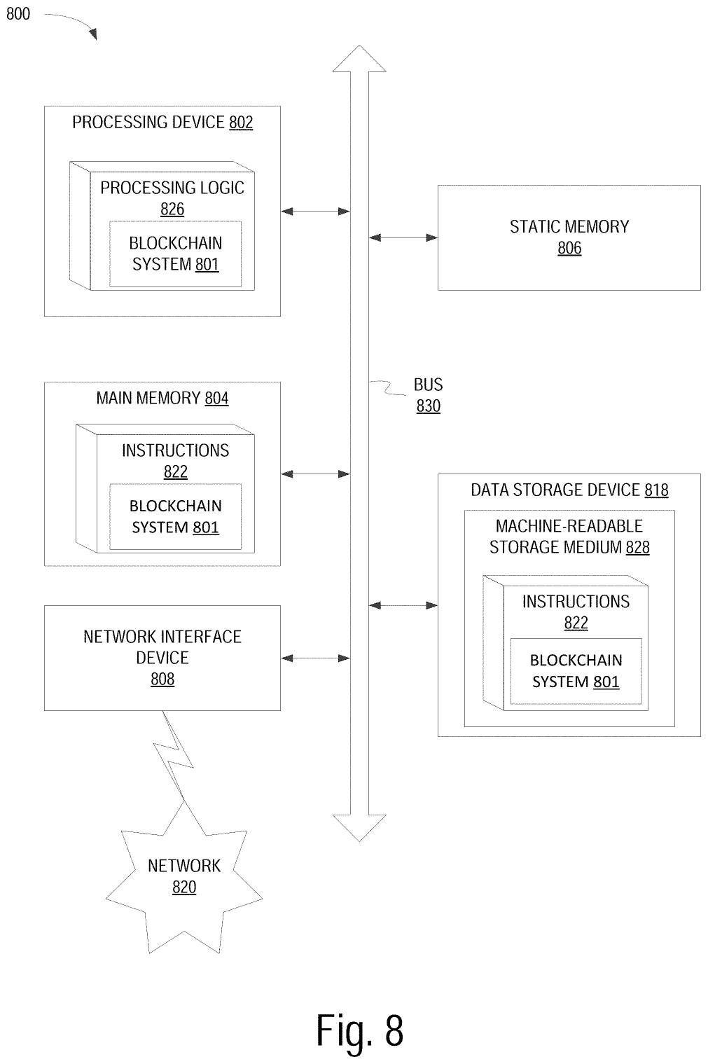

FIG. 8 illustrates a diagrammatic representation of a machine in the example form of a computer system 800 within which a set of instructions may be executed for causing the machine to perform any one or more of the methodologies discussed herein. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 800 may be representative of a server computer system, such as a blockchain system as described herein.

The exemplary computer system 800 includes a processing device 802, a main memory 804 (e.g., read-only memory (ROM), flash memory, dynamic random access memory (DRAM), a static memory 806 (e.g., flash memory, static random access memory (SRAM), etc.), and a data storage device 818, which communicate with each other via a bus 830. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 802 represents one or more general-purpose processing devices such as a microprocessor, central processing unit, or the like. More particularly, the processing device may be a complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute processing logic 826, which may be one example of a blockchain system 801 for performing the operations and steps discussed herein.

The data storage device 818 may include a machine-readable storage medium 828, on which is stored one or more sets of instructions 822 (e.g., software) embodying any one or more of the methodologies of functions described herein, including instructions to cause the processing device 802 to execute blockchain system 801. The instructions 822 may also reside, completely or at least partially, within the main memory 804 or within the processing device 802 during execution thereof by the computer system 800; the main memory 804 and the processing device 802 also constituting machine-readable storage media. The instructions 822 may further be transmitted or received over a network 820 via the network interface device 808.

The machine-readable storage medium 828 may also be used to store instructions to perform the methods and operations described herein. While the machine-readable storage medium 828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art; these also are intended to be encompassed by the following claims. The claims may encompass embodiments in hardware, software, or a combination thereof.

What is claimed is:

1. A method of using a blockchain to establish a web of trust, the method comprising:
receiving a request to add a transaction to a blockchain, wherein the transaction identifies a sale of a good or service;
determining that a prior transaction identifying the good or service is not already stored on the blockchain; and
in response to determining that the prior transaction identifying the good or service is not already stored on the blockchain:
sending, by a processing device, a first request to a first third-party institution to verify information of the transaction;
in response to sending the first request, receiving a first verification of the information of the transaction from the first third-party institution; and
adding, by the processing device, the first verification, in a first verification transaction, to the blockchain.

2. The method of using a blockchain to establish a web of trust of claim 1, further comprising:
determining whether the first third-party institution is a trusted institution; and
in response to determining that the first third-party institution is not a trusted institution:
sending a second request to a second third-party institution to verify information of the transaction;
receiving a second verification of the information of the transaction from the third-party institution;
adding the second verification, in a second verification transaction, to the blockchain; and
in response to receiving the second verification, adding the transaction to the blockchain.

3. The method of using a blockchain to establish a web of trust of claim 2, wherein determining whether the first third-party institution is a trusted institution comprises at least one of:
determining that a recent signed transaction from a second third-party institution verifies that the first third-party institution can be trusted;
determining that a chain of verification transactions already on the blockchain verifies that the second third-party institution can be trusted; and
determining that the chain of verification transactions includes an institution that is on a list of trusted institutions verified by a plurality of blockchain peers; or
determining that the first third-party institution is on the list of trusted institutions verified by the plurality of blockchain peers.

4. The method of using a blockchain to establish a web of trust of claim 1, further comprising:
determining that the first third-party institution has not been verified on the blockchain;
sending a second request to a second third-party institution to verify the first third-party institution;
receiving a second verification of the first third-party institution from the second third-party institution;
adding the second verification, in a second verification transaction, to the blockchain; and
in response to receiving the second verification, adding the transaction to the blockchain

5. The method of using blockchain to establish a web of trust of claim 4, wherein the first verification and the second verification represent a directed path in a larger directed graph of verification transactions on the blockchain.

6. The method of using a blockchain to establish a web of trust of claim 1, further comprising:
determining that the first third-party institution is a trusted institution; and
in response to receiving the first verification, adding the transaction to the blockchain.

7. The method of using a blockchain to establish a web of trust of claim 6, further comprising compressing the transaction before adding the transaction to the blockchain.

8. The method of using a blockchain to establish a web of trust of claim 1, wherein the first verification comprises a unique digital signature of the first third-party institution.

9. The method of using a blockchain to establish a web of trust of claim 1, further comprising:
identifying a recent transaction on the blockchain in which the commodity that was sold is the same commodity that is being sold in the new transaction;
identifying a buyer identified in the recent transaction;
determining that the buyer of the recent transaction is not the same as the seller of the transaction;
sending a second request to a second third-party institution to construct any missing transactions that occurred after the recent transaction and before the transaction;
receiving the missing transactions from the second third-party institution;
adding the missing transactions to the blockchain; and
adding the new transaction to the blockchain after adding the missing transactions.

10. A blockchain verification system comprising:
a memory; and
a processing device, operatively coupled to the memory, to:
receive a request to add a transaction to a blockchain, wherein the transaction identifies a sale of a good or service;
determine that a prior transaction identifying the good or service is already stored on the blockchain; and
in response to determining that the prior transaction identifying the good or service is already stored on the blockchain:
determine whether seller information of the transaction is the same as buyer information of the prior transaction;
in response to determining that the seller information is the same as the buyer information, add the transaction to the blockchain; and
in response to determining that the seller information is not the same as the buyer information, send a first request to a first third-party institution to verify information of the transaction.

11. The blockchain verification system of claim 10, wherein, in response to determining that the seller information is not the same as the buyer information, the processing device is further to:
receive a first verification of the information of the transaction from the first third-party institution; and
add the first verification, in a first verification transaction, to the blockchain.

12. The blockchain verification system of claim 11, the processing device further to:
determine that the first third-party institution is not a trusted institution; and
in response to determining that the first third-party institution is not a trusted institution:
send a second request to a second third-party institution to verify the information of the transaction block;
receive a second verification of the information of the transaction block from the third-party institution;
add the second verification, in a second verification block, to the blockchain; and
in response to receiving the second verification, add the transaction to the blockchain.

13. The blockchain verification system of claim 11, the processing device further to:
determine that the first third-party institution is a trusted institution; and
in response to receiving the first verification, add the transaction to the blockchain.

14. The blockchain verification system of claim 113, the processing device further to add a missing transaction to the blockchain in response to a determination that the web of trust is incomplete.

15. The blockchain verification system of claim 11, wherein the first verification comprises a unique digital signature of the first third-party institution.

16. A non-transitory computer-readable storage medium having instructions stored thereon that, when executed by a processing device, cause the processing device to:
receive a request to add a transaction to a blockchain, wherein the transaction identifies a sale of a good or service;
determine that a prior transaction identifying the good or service is not already stored on the blockchain; and
in response to determining that the prior transaction identifying the good or service is not already stored on the blockchain:
send, by the processing device, a first request to a first third-party institution to verify information of the transaction;
in response to sending the first request, receive a first verification of the information of the transaction from the first third-party institution; and
add, by the processing device, the first verification, in a first verification transaction, to the blockchain.

17. The non-transitory computer-readable storage medium of claim 16, the processing device further to:
determine that the first third-party institution is not a trusted institution; and
in response to determining that the first third-party institution is not a trusted institution:
send a second request to a second third-party institution to verify the information of the transaction block;
receive a second verification of the information of the transaction block from the third-party institution;
add the second verification, in a second verification transaction, to the blockchain; and
in response to receiving the second verification, add the transaction to the blockchain.

18. The non-transitory computer-readable storage medium of claim 16, the processing device further to:
determine that the first third-party institution is a trusted institution; and
in response to receiving the first verification, add the transaction to the blockchain.

19. The non-transitory computer-readable storage medium of claim 18, the processing device further to compress the transaction before adding the transaction to the blockchain.

20. The non-transitory computer-readable storage medium of claim 16, the processing device further to add a missing transaction to the blockchain in response to a determination that the web of trust is incomplete.
